(19) United States
(12) Patent Application Publication
(10) Pub. No.: US 2020/0267897 A1
(43) Pub. Date: Aug. 27, 2020

(54) INSERT COMPRISED OF HARD METAL FOR AN AGRICULTURAL IMPLEMENT

(71) Applicant: BOEHLERIT GmbH & Co.KG., Kapfenberg (AT)

(72) Inventors: Hannes BURBÖCK, Kindberg/Aumühl (AT); Erhard SATTLER, Obdach (AT); Walter BÄRNTHALER, St. Marein im Mürztal (AT)

(73) Assignee: BOEHLERIT GmbH & Co.KG., Kapfenberg (AT)

(21) Appl. No.: 16/800,306

(22) Filed: Feb. 25, 2020

(30) Foreign Application Priority Data
Feb. 26, 2019 (AT) A 50153/2019

(51) Int. Cl. A01D 34/73; A01D 25/00

(52) U.S. Cl. CPC A01D 34/73; A01D 25/005; B23B 2200/202; B23B 2200/083; B23B 2200/081

(57) ABSTRACT

An insert of hard metal for an agricultural device, for example a grubbing share or a mower blade, having actively cutting areas that act in a cutting direction. Teeth are at least partially provided between the actively cutting areas, which viewed from above protrude over the actively cutting areas.

The invention relates to an insert comprised of hard metal for an agricultural device, for example a grubbing share or a mower blade, having actively cutting areas that act in a cutting direction.

Agricultural implements are often equipped with blades for various purposes. The blades can have different purposes, for example a cultivator tip for cutting through soil at a predetermined height to make the ground workable, but also for chopping straw, cutting through bales or enabling a cut in some other way.

The actively cutting elements required to this end were fabricated out of steel for many decades. A switch has recently been made to fitting corresponding wear parts made out of steel with hard metal, so as to increase the longevity many times over. While the procurement costs are far higher, these higher procurement costs still pay off over the life of the wear part. Scaled to the procurement costs, the service life for wear parts fitted with hard metal is thus basically higher for agricultural implements.

Depending on the application, various solutions have already been proposed for fitting separate agricultural implements and elements for the latter, for example ploughshares or choppers, with hard metal individually and tailored to the geometry. However, this requires that an application which considers the geometry of the respective wear part be developed for each separate area of application. In addition, there exists interest in increasing the stability even further, so as to achieve an even higher productivity relative to the life of a cutting wear element.

The object of the invention is to further develop an insert of the kind mentioned at the outset in such a way as to satisfy the above requirements.

This object is achieved for an insert of the kind mentioned at the outset by at least partially providing teeth between the actively cutting areas, which viewed from above protrude over the actively cutting areas.

This solution provides an insert that can be arranged on a cultivator tip, a grubbing share, a mower blade or other components that can comprise part of a larger implement, for example. Two advantages are here achieved in particular: On the one hand, precautions are taken to maximize a longevity of the insert largely independently of a specific intended purpose. In this conjunction, the protruding teeth serve to absorb impacts caused by rocks, more solid soil or generally hard materials, for example, and thereby protect the recessed actively cutting areas only intended to engage later. For example, if a rock hits one or several teeth, the latter are subject to wear, but not the actively cutting areas that only engage to make cuts later. On the other hand, this type of insert can be fastened to nearly any kind of component required for cutting in agriculture via integral bonding, for example. This ranges from processing soil to cutting straw. A quasi universal insert is thus involved, which once developed can be used for a plurality of agricultural processing implements. This also allows an efficient and sparingly intensive provisioning and storage, which in turn permits a quick replacement.

For the reasons explained above, it is preferred that at least some actively cutting areas lie completely behind the adjacent teeth with the insert viewed from above. If the actively cutting areas run completely behind the teeth, they cannot be damaged by the hard material.

It can be provided that the teeth be elevated in design in relation to cutting edges of the actively cutting areas. Since the teeth are intended to absorb impacts by rocks or hard materials in general, the teeth are also subject to a rather significant level of wear. This is addressed by an elevated design for the teeth, so that excess material is present in the area of the teeth on the front side of the insert with the running, actively cutting areas on the one hand and the teeth on the other.

As a rule, the actively cutting areas are arranged between the teeth. This notwithstanding, the teeth can themselves also be actively cutting, if designed with corresponding cutting edges. However, this is basically not necessary, since the teeth are provided for another purpose.

There can basically be as many teeth as desired. At least three teeth are usually provided, which separate actively cutting areas from each other. The selected distance between the teeth is here generally such that two or more teeth can absorb an impact, for example the impact of a rock. The teeth can here each be arranged at the same distance from each other. However, it is also possible to provide varying distances between the teeth, for example which can follow a specific pattern. It is possible to alternate between shorter and longer distances, or even to configure the distance between the teeth in the center of the insert differently than in the edge regions thereof.

The actively cutting areas are recessed, but can here have any contour desired in terms of height. For many applications, it is favorable that the individual, actively cutting areas resemble straight lines as viewed from the front, so that the entire actively cutting area is at one height. The various actively cutting areas can also each lie at the same height as viewed from the front, so that a continuous cutting line separated only by the teeth mentally arises given a front view.

The insert is comprised of a hard metal, which does not absolutely require that it be integral in design, even though this is easier from a production standpoint, and thus preferred.

The insert can basically consist of any hard metal desired. However, it has been shown that hard metal types with about 80 percent by weight (hereinafter % w/w) to 95% w/w as well as a binding metal, preferably cobalt, in an amount of 5% w/w to 15% w/w, preferably of 7% w/w to 13% w/w, in particular of 3% w/w to 12% w/w, is expedient, wherein the tungsten carbide is present with an average grain size ranging from about 1.5 μm to 5 μm, in particular 2.0 μm to 3.0 μm. Corresponding hard metal types have proven suitable for cutting performances in the agricultural sector. It can also be provided that the insert be coated. Coatings applied in CVD or PVD processes are possible for this purpose. For example, the coatings can be Al₁₋ₓTiₓN type coatings. Corresponding coatings can have a layer thickness of up to 15 μm, for example. Also possible are coatings with alternating coating layers of varying composition.

Based on the advantages described above, an insert according to the invention is used in an agricultural implement. For example, the agricultural implement can be a straw shredder blade, a mower blade, a beet-topping cutter, a pruning hammer, a flail mover blade, loading wagon blades, balers and fodder mixing plants, grubbing shares or a disk for a disk harrow. Additional features, advantages and effects of the invention may be gleaned from the exemplary embodiments presented below. The drawings hereby referenced show:

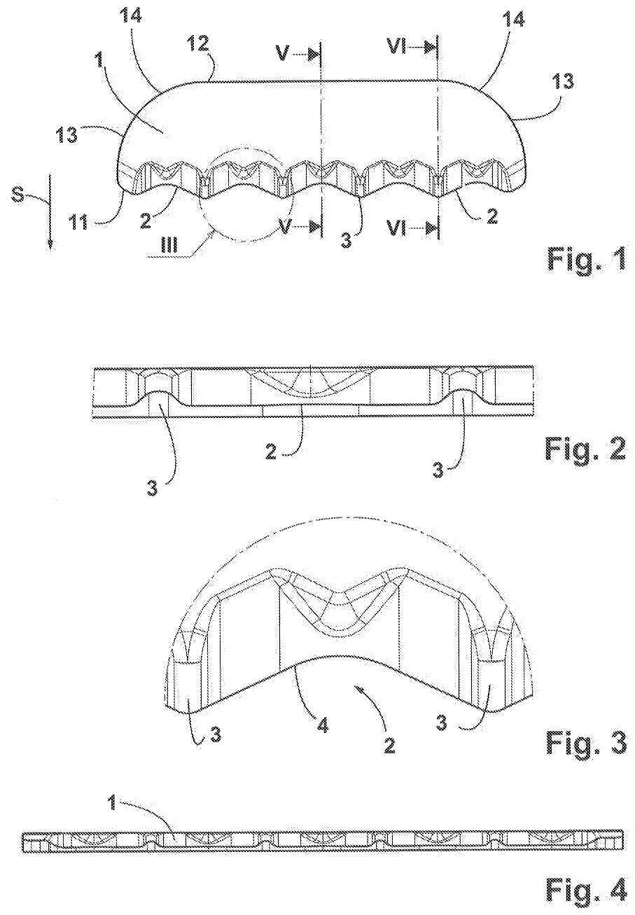

FIG. 1 a top view of an insert according to the invention;

FIG. 2 a part of a front view of the insert from FIG. 1;

FIG. 3 a magnified illustration of the section III on FIG. 1;

FIG. 4 a complete front view of the insert from FIG. 1;

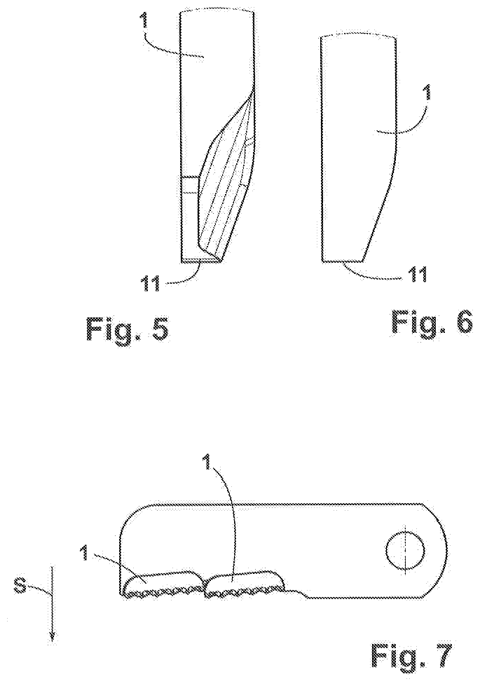

FIG. 5 a section along the line V-V on FIG. 1;

FIG. 6 a section along the line VI-VI on FIG. 1;

FIG. 7 a straw shredder blade;

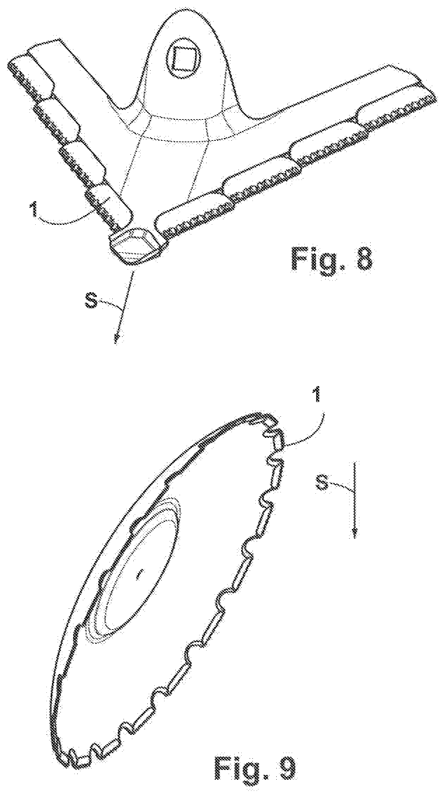

FIG. 8 a grubbing share;

FIG. 9 a disk for a disk harrow;

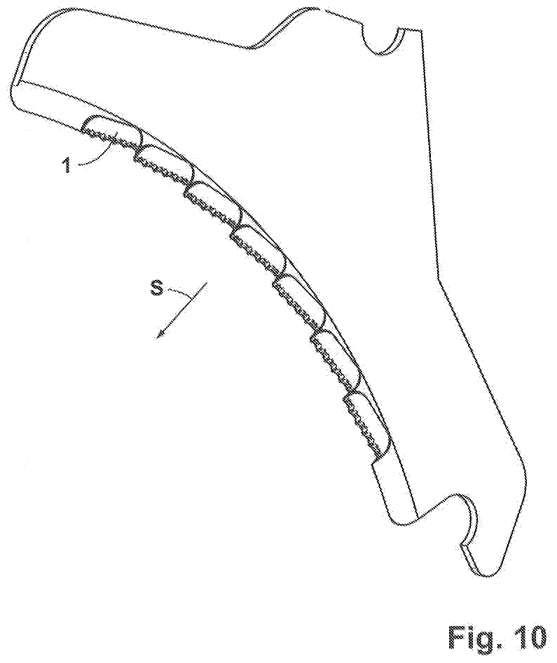

FIG. 10 a baler blade.

FIG. 1 shows an insert 1 according to the invention. The insert has an integral design, even though it is also possible for the insert 1 to be composed of several parts with the same geometric shape. It is advantageous both generally and for the insert 1 that the latter be integral in design.

The insert 1 consists of a hard metal. The hard metal can be a common hard metal. Preference goes to types with roughly an average size, i.e., those that do not fit the classic definition of a fine grain, but are also not too coarse. It has proven especially beneficial in practice that an average grain size of the hard material particles, for example tungsten carbide, range between 2.0 μm and 3.0 μm. The normally used cobalt is preferably applied as the binding metal, even though other binding metals based on nickel and/or iron are possible as well. Also possible are combinations of these latter metals with cobalt as well as a combination of cobalt with nickel and iron as the binding metal. A percentage of hard material particles, such as tungsten carbide, usually ranges from 88% w/w to 95% w/w, in particular from about 88% w/w to 92% w/w. The remainder is comprised of the binding metal cobalt, for example. Of course, it is also possible that at least a portion of the tungsten carbide be replaced by other hard material particles, for example titanium carbide.

The insert 1 has a front side 11 and an opposing rear side 12. The front side 11 and rear side 12 are connected with each other on the insert 1 by connecting sides 13, as visible from the top view on FIG. 1. Provided at the transition from the rear side 12 in the connecting sides 13 are rounded areas 14, even though the corresponding transitions could also be angular in design. However, the rounded areas 14 have proven themselves expedient for attaching the insert 3 in an agricultural implement or a component for the latter, a process yet to be described below. The front side 11 of the insert 1 has roughly a zigzag structure as viewed from above. The zigzag structure is defined by actively cutting areas 2 and teeth 3. The teeth 3 are basically each arranged between the actively cutting areas 2. The zigzag structure can also be sealed off on the outside by additional teeth 3. In this case, no additional actively cutting areas adjoin the outermost teeth 3 arranged on the outside. In the embodiment variant depicted on FIG. 1, however, each respective tooth 3 is enveloped by two adjacent, actively cutting areas 2.

As especially clearly evident from the top view on FIG. 1, the actively cutting areas 2 are recessed in relation to the teeth 3. If the insert 1 fastened to an agricultural implement or a component for an agricultural implement that is in turn fastened to the agricultural implement is effectively moved in the direction of a cutting direction S, the teeth 3 serve as quasi-crash zones, for example which can be hit by rocks, but without them reaching the actively cutting areas 2. To this end, the teeth 3 are spaced apart from each other by a distance of about 5 mm to 25 mm, preferably of 6 mm to 20 mm. The specific distance depends on the expected loads or material to be processed, and can be set as a function thereof, for example for processing soil or cutting straw. As a consequence, the teeth 3 also intercept any impacts, so that the actively cutting areas 2 are correspondingly protected.

As evident in the front view on FIG. 2, the teeth 3 offset relative to each other are elevated in relation to the actively cutting areas 2, and must thus be regarded as a material reinforcement. This material reinforcement of the teeth 3 satisfies a dual functional principle: While the actively cutting, recessed areas 2 are intended to allow a cutting of material for as long as possible, the teeth 3 are intended to eliminate impacts and other disruptions that basically diminish the service life of the actively cutting areas. This design of the insert 1 makes it possible to achieve a very good service life. Since the teeth 3 are also designed with an elevation, for example an elevation of up to 1 mm, in relation to the actively cutting areas 2 as the baseline, the teeth 3 can be kept relatively narrow without impairing the function. The width of the teeth 3 along the zigzag structure (see FIG. 1 or FIG. 2) is usually less than 30%, preferably less than 25%, especially preferably less than 20%, of the length of an actively cutting area 2 lying in between.

As evident on FIG. 2, the front side 11 of the insert 1 is tapered in design in terms of the thickness, which makes sense for a good cutting effect. In the adjacent area, the insert 1 is designed with a constant thickness. Also evident from FIG. 2 in particular is the elevated configuration of the teeth 3 in relation to the actively cutting areas 2, as shown on FIG. 4 for a complete front view.

FIG. 3 shows a cutout III according to FIG. 1. As evident, the depicted actively cutting area 2 adjoined by two teeth 3 is essentially V-shaped in design. As shown, it may here be best to avoid any corners by using rounded areas. This diminishes the risk, that the insert 1 will break out at certain points, since tension peaks are reduced. On FIG. 3, the actively cutting area 2 forms cutting edges 4, which deliver the actual cutting performance in the insert.

FIG. 5 shows a section along the line V-V on FIG. 1, and FIG. 6 a corresponding section along the line VI-VI, also on FIG. 1. As evident yet again from these sectional illustrations, the insert 1 tapers conically on the front side 11, wherein the teeth 3 are configured with an elevation or more material by comparison to the actively cutting areas 2.

An insert 1 according to the invention can be used in any components for agricultural implements or even in the latter themselves, for example as a straw shredder blade, mower blade, beet-topping cutter, pruning hammer, flail mover blade, loading wagon blades, balers and fodder mixing plants, grubbing shares or in a dish for a disk harrow. Several exemplary embodiments for the above will be shown below. For example, FIG. 7 shows a straw shredder blade, FIG. 8 grubbing snares, FIG. 9 a disk for a disk harrow, and FIG. 10 a baler blade. All exemplary embodiments share in common that an insert 1 according to the invention is used. Even if not mandatory, a respective plurality of inserts 1 is provided in the exemplary embodiments, which act in a cutting direction S. The inserts 1 are here usually positioned at an angle of attack relative to the base of the respective tool of about 5° to 25°, in particular of 10° to 20°. The inserts 1 can be secured to the corresponding components or tools via soldering. It is here preferred that the insert 1 be spaced apart at least minimally from the respective next insert 1. However, it is also possible that the individual inserts 1 be arranged so as to adjoin or contact each other. Regardless of the kind of tool or the component, it is especially advantageous for accommodating one or several inserts 1 that pockets corresponding thereto be provided, into which the inserts 1 are placed. Fastening can take place integrally, in particular via soldering.

One essential advantage to an insert 1 according to the invention apart from a high service life is also that the insert 1 can be used in nearly any agricultural implements or components for the latter, as also evident from the exemplary embodiments according to FIG. 7 to FIG. 10. This significantly reduces warehousing, since the same parts can always be used.

1. An insert comprised of hard metal for an agricultural device, for example a grubbing share or a mower blade, having actively cutting areas that act in a cutting direction, wherein teeth are at least partially provided between the actively cutting areas, which viewed from above protrude over the actively cutting areas.

2. The insert according to claim 1, wherein at least individual, actively cutting areas lie completely behind the adjacent teeth as viewed from above.

3. The insert according to claim 1, wherein the teeth are elevated in design in relation to cutting edges of the actively cutting areas.

4. The insert according to claim 1, wherein the actively cutting areas are designed with a roughly V-shaped progression as viewed from above.

5. The insert according to claim 1, wherein at least three teeth are provided, which separate the actively cutting areas from each other.

6. The insert according to claim 1, wherein the actively cutting areas lie at the same height as viewed from the front.

7. The insert according to claim 1, wherein the insert is integral in design.

8. The insert according to claim 1, wherein the insert is coated.

9. An agricultural implement with an insert according to claim 1.
